(19) United States
(12) Patent Application Publication
(10) Pub. No.: US 2020/0125879 A1
(43) Pub. Date: Apr. 23, 2020

(54) APPARATUS AND METHOD FOR CAPTURING FLYING OBJECTS

(71) Applicant: TARSIER TECHNOLOGIES, INC., San Francisco, CA (US)

(72) Inventor: Markus Diehl, Nuernberg (DE)

(21) Appl. No.: 16/658,238

(22) Filed: Oct. 21, 2019

(30) Foreign Application Priority Data
Oct. 19, 2018 (DE) 10 2018 008 282.3

(51) Int. Cl. G06K 9/32; G06K 9/62; G06K 9/00; G06N 3/02

(52) U.S. Cl. CPC G06K 9/3233; G06K 9/6227; B64C 39/024; G06K 9/00671; G06N 3/02; G06K 9/00718

(57) ABSTRACT

An apparatus for capturing flying objects has a camera system with at least one camera for video monitoring a monitoring space, and a control unit for controlling the camera system and evaluating the video frames captured by the camera arrangement. The camera system can selectively operate in a non-zoom mode or in a zoom mode. Recognizing a flying object of interest in the monitoring space is accomplished on the basis of a multi-stage classification of flying objects in a region of interest initially based on video frames captured by the camera system in the non-zoom mode and then possibly on video frames captured by the camera system in the zoom mode.

### CROSS-REFERENCE TO RELATED APPLICATION

This application claims the priority, under 35 U.S.C. § 119, of German application DE 10 2018 008 282.3, filed Oct. 19, 2018; the prior application is herewith incorporated by reference in its entirety.

### BACKGROUND OF THE INVENTION

### Field of the Invention

The present invention relates to an apparatus and to a method for capturing flying objects in a monitoring space.

Unmanned aerial vehicles (UAV), frequently also referred to as drones, are used more and more to scout or attack for example protected locations such as prisons, airports, military facilities, government buildings, etc. or to smuggle objects inside. For example, prohibited objects such as drugs, weapons or mobile phones are transported with increasing frequency over prison walls to prisoners using drones. For this reason, there is a need for a protection system against unauthorized use of such flying objects.

### SUMMARY OF THE INVENTION

It is the object of the invention to provide a solution for capturing flying objects with which flying objects in a monitoring space can be reliably captured and recognized.

This object is achieved by means of the teaching in the independent claims. The dependent claims relate to particularly advantageous configurations and developments of the invention.

According to a first aspect of the invention, the apparatus for capturing flying objects has a camera arrangement with at least one camera for video monitoring a monitoring space, and a control unit for controlling the camera arrangement and evaluating the video frames captured by the camera arrangement, wherein the camera arrangement is configured to selectively operate in non-zoom mode or in zoom mode. In addition, the control unit is configured to determine a region of interest with a flying object based on video frames captured by the camera arrangement in non-zoom mode and to ascertain a first probability of the presence of a flying object of interest in the determined region of interest in order to switch the camera arrangement to zoom mode in the direction of the determined region of interest if a first limit value is exceeded by the ascertained first probability in order to ascertain a second probability of the presence of a flying object of interest in the determined region of interest on the basis of video frames captured by the camera arrangement in zoom mode and to recognize a flying object of interest in the region of interest if a second limit value is exceeded by the ascertained second probability.

Using the monitoring apparatus according to the invention, capturing and recognition of flying objects in the monitoring space is performed on the basis of a multi-stage classification of flying objects in a region of interest (ROI). In a first stage, classification is performed based on video frames captured by the camera arrangement in non-zoom mode and, if the result is positive, classification is performed in a second stage based on video frames captured by the camera arrangement in zoom mode. The second limit value is preferably higher than the first limit value, that is to say the second classification stage based on video frames captured by the camera arrangement in zoom mode is more precise than the first classification stage in which initially a pre-selection of relevant regions of interest is made. With such multi-stage classification, it is possible to reliably capture and recognize flying objects of interest in a monitoring space using a monitoring apparatus of relatively simple and cost-effective design. In this multi-stage classification, it is also possible to reduce the number of pixels required in the first classification stage for the pre-selection of a region of interest.

Flying objects that can be captured with the monitoring apparatus according to the invention include—depending on the application—in particular unmanned aerial vehicles (UAVs), helicopters, aircraft, birds, and the like. Flying objects of interest in this context designate capturable flying objects that—depending on their use—are relevant and should therefore be identified. The flying objects of interest in this context include in particular unmanned aerial vehicles (UAVs), without the invention being intended to be limited to flying objects of this type.

The camera arrangement contains one or more cameras for capturing or recording video frames and can selectively operate in non-zoom mode or in zoom mode. In this context, non-zoom mode is to be understood to mean the operation of all cameras of the camera arrangement in their respective base setting so as to capture substantially the entire monitoring space using the entire camera arrangement, with panning and tilting movements of the cameras also being possible. In other words, the cameras in non-zoom mode are not necessarily operated with their largest fields of view but can also optionally operate with a specific zoom factor. Neither is it necessary for all cameras of the camera arrangement to have the same base setting with respect to the zoom factor. In zoom mode of the camera arrangement, at least one of the cameras operates with a zoom factor that is greater than the base setting. In the case of a camera arrangement having a plurality of cameras, in zoom mode of the camera arrangement, some cameras can continue to operate in their respective base setting such as non-zoom mode to continuously capture video frames for the first classification stage, while at least one camera operates with a greater zoom factor to capture the video frames for the second classification stage.

To ascertain the second probability, the camera arrangement is switched to zoom mode in the direction of the captured region of interest. This is intended to mean that at least one camera of the camera arrangement zooms in on the region of interest, wherein this can be accomplished by way of a direction setting of a camera and/or by selecting a camera from the camera arrangement.

The probability of the presence of a flying object of interest in the determined region of interest in this context is intended to mean a probability that the object in the region of interest is a specific flying object of interest (for example a specific type of UAV) or any flying object of interest (for example any UAV). The probability is preferably ascertained as an average value of a plurality of video frames. The probability is preferably ascertained using neural networks. The probability is preferably ascertained in the form of a confidence level. Preferably, the first probability contains a probability of the presence of a flying object of interest or of a similar flying object and the second probability contains only a probability of the presence of a flying object of interest.

In one configuration of the invention, the camera arrangement has at least one PTZ camera, which can selectively operate in non-zoom mode or in zoom mode. In this configuration, the at least one PTZ camera preferably captures both the video frames for the first classification stage and the video frames for the second classification stage. That is to say, the PTZ camera initially scans the monitoring space with a low zoom factor as per the base setting and subsequently zooms in on the region of interest if in the first classification stage a flying object of interest is assumed to be located therein. The camera arrangement preferably contains a plurality of PTZ cameras to ensure higher reliability of video monitoring and possibly also to be able to classify or track a plurality of regions of interest in parallel. A PTZ camera can be panned to the side and tilted up and down and has a zoom function (“pan-tilt-zoom”).

In another configuration of the invention, the camera arrangement has at least one static camera that operates only in non-zoom mode and at least one PTZ camera that can operate in zoom mode. In this configuration, the at least one static camera captures the video frames for the first classification stage with a low zoom factor, and the at least one PTZ camera captures the video frames for the second classification stage with a higher zoom factor. Alternatively, the at least one static camera and the at least one PTZ camera can in this configuration capture the video frames for the first classification stage with a low zoom factor, and then the at least one PTZ camera can capture the video frames for the second classification stage with a higher zoom factor. The camera arrangement preferably comprises a plurality of PTZ cameras to possibly also be able to classify or track a plurality of regions of interest in parallel. The static cameras can be equipped with fisheye lenses so as to be able to capture a larger field in the monitoring space.

In one configuration of the invention, the control unit is additionally configured to control, if the presence of a flying object of interest in the region of interest has been detected, the camera arrangement operating in zoom mode to track the flying object of interest.

In one configuration of the invention, the control unit is furthermore configured to additionally determine, if the presence of a flying object of interest in the region of interest has been detected, a distance of the flying object of interest. The determination of a distance can be effected in the case of a camera arrangement having a plurality of cameras for example using a triangulation method. The determination of the distance can also be performed with only one camera on the basis of the zoom factor and a known size of the flying object that was identified.

In a further configuration of the invention, the camera arrangement has at least one camera having a gated viewing functionality. The gated viewing functionality facilitates or improves video monitoring in particular under impaired visibility conditions such as fog.

The camera arrangement is preferably also equipped with (near) infrared illumination, with the result that the monitoring apparatus can function effectively even under poor visibility conditions such as at night. The infrared illumination preferably uses a wavelength of, for example, approximately 850 nm or approximately 940 nm, which is adapted to the camera sensitivity.

In a further configuration of the invention, the camera arrangement has at least one black-and-white camera. A B/W camera offers better resolution than a color camera and can in this way improve the classification of the captured flying objects. Depending on the embodiment of the camera arrangement, PTZ cameras and/or static cameras can be embodied as B/W cameras.

In a further configuration of the invention, the camera arrangement has a plurality of cameras that can operate in non-zoom mode and the fields of view of which are aligned in relation to one another. For example, the video frames captured by the plurality of cameras can be combined to form a wide panorama image of the entire monitoring space for a user of the monitoring apparatus.

In a still further configuration of the invention, the control unit has an interface for passing on the evaluation results to an existing security system at a protected location and/or to a remote user. The evaluation results contain for example a warning signal, information relating to the recognized flying object of interest, results of the distance measurement, video frames of the determined region of interest, video frames of the entire monitoring space, and the like. The evaluation results can be passed on for example using a radio network or via the Internet.

According to a second aspect of the invention, the method for capturing flying objects has the steps of capturing video frames of a monitoring space using a camera arrangement with at least one camera in non-zoom mode; determining a region of interest with a flying object based on video frames captured by the camera arrangement in non-zoom mode; ascertaining a first probability of the presence of a flying object of interest in the determined region of interest; capturing video frames using the camera arrangement in zoom mode in the direction of the determined region of interest if the ascertained first probability exceeds a first limit value; ascertaining a second probability of the presence of a flying object of interest in the determined region of interest on the basis of video frames captured by the camera arrangement in zoom mode; and recognizing a flying object of interest in the region of interest if the ascertained second probability exceeds a second limit value.

It is possible to achieve the same advantages with this method as with the above-described monitoring apparatus of the invention. As regards the advantage, explanations of terminology, and preferred embodiments of the method, reference is additionally made to the above statements in connection with the monitoring apparatus according to the invention.

The video frames are preferably captured in zoom mode of the camera arrangement using at least one PTZ camera, that is to say using one or more PTZ cameras. In non-zoom mode of the camera arrangement, the video frames are preferably captured using at least one PTZ camera and/or at least one static camera, preferably using a plurality of PTZ cameras or a plurality of static cameras.

Ascertaining the first probability and/or ascertaining the second probability of the presence of a flying object of interest in the determined region of interest is preferably accomplished by evaluating the video frames captured by the camera arrangement using neural networks. The neural networks can preferably be trained by deep learning, as it is called. Alternatively or additionally thereto, ascertaining the probabilities can also be accomplished by comparing the captured video frames to stored image data.

In one configuration of the invention, ascertaining the first probability and/or ascertaining the second probability of the presence of a flying object of interest in the determined region of interest is accomplished by assigning flying object classes to each pixel in the determined region of interest. In this way, the error rate of the classification can be reduced as compared to an evaluation in which a flying object class is assigned to the entire determined region of interest.

In one configuration of the invention, it is also possible to use synthetic images for ascertaining the probabilities of the presence of a flying object of interest. For example, the images used in the control unit for the deep learning of the neural networks and/or the image data that are available for the control unit can comprise not only tagged drone images and images of real drones recorded in the monitoring space, but also images that were recorded in the monitoring space and have been supplemented synthetically by diverse drones or scenarios. In this way, the quality of the classification of the flying objects of interest can be improved.

In one configuration of the invention, the recognized flying object of interest in the region of interest can subsequently be tracked using the camera arrangement in zoom mode.

In a further configuration of the invention, it is additionally possible to determine a distance of the recognized flying object of interest in the region of interest. The determination of a distance can be effected in the case of a camera arrangement having a plurality of cameras for example using a triangulation method. The determination of the distance can also be performed with only one camera on the basis of the zoom factor and a known size of the flying object that was identified.

In a further configuration of the invention, if a flying object of interest in a region of interest was recognized, the results of the flying object capturing can be passed on to an existing security system at a protected location and/or to a remote user. The results of the flying object capturing that have been passed on contain for example a warning signal, information relating to the recognized flying object of interest, results of the distance measurement, video frames of the determined region of interest, video frames of the entire monitoring space, and the like. The results can be passed on for example using a radio network or via the Internet.

In a further configuration, the video frames captured by the camera arrangement are stored. In particular, the video frames captured by the camera arrangement are stored if a flying object of interest in a region of interest was recognized. The stored video frames can be used at a later time for example to check or repeat the evaluation, to be able to demonstrate the evaluation results, and the like.

In a further configuration of the invention, the video frames in non-zoom mode of the camera arrangement are captured using a plurality of cameras, the fields of view of which are aligned with respect to one another. In this configuration, the video frames captured by the plurality of cameras can be combined to form a wide panorama image of the entire monitoring space for a user. It is then also possible to mark in this wide panorama image the region of interest which is zoomed to recognize the flying object of interest.

The above and further features and advantages of the invention will be better understood from the following description of preferred, non-limiting exemplary embodiments with reference to the appended drawing.

Other features which are considered as characteristic for the invention are set forth in the appended claims.

Although the invention is illustrated and described herein as embodied in an apparatus and a method for capturing flying objects, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an illustration showing the construction of a monitoring apparatus according to a first exemplary embodiment of the invention;

FIG. 2 is an illustration showing the construction of the monitoring apparatus according to a second exemplary embodiment of the invention; and

FIG. 3 is a flowchart of a method for capturing flying objects according to an exemplary embodiment of the invention.

### DETAILED DESCRIPTION OF THE INVENTION

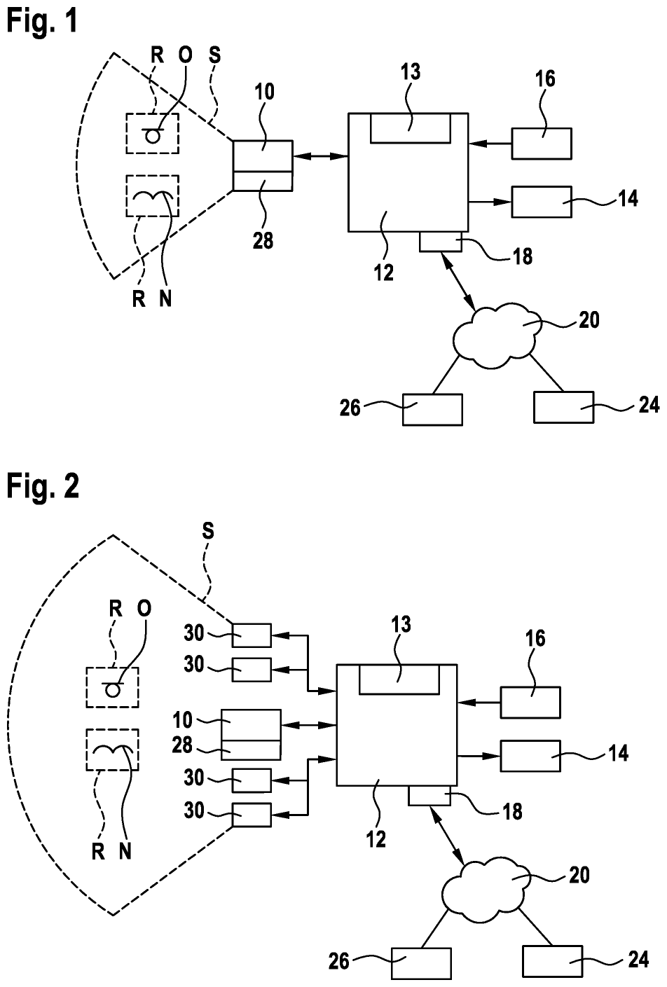

Referring now to the figures of the drawings in detail and first, particularly to FIG. 1 thereof, there is shown a monitoring apparatus according to the invention that will be explained in more details below using the example of drone monitoring. However, the apparatus according to the invention and the method according to the invention can likewise be used for capturing and recognizing other flying objects of interest, such as aircraft or birds. The apparatus according to the invention and the method according to the invention could moreover also be used to capture and recognize other objects, such as for example people or stationary objects.

FIG. 1 shows a first exemplary embodiment of a monitoring apparatus according to the invention.

The monitoring apparatus contains a PTZ camera 10 for video monitoring a monitoring space S, in which flying objects of interest O such as unmanned aerial vehicles (UAVs), or drones, and flying objects that are not of interest N, such as birds or aircraft, can appear. The PTZ camera 10 used can optionally also be a black-and-white camera, with which a higher resolution can be attained.

The PTZ camera 10 is optionally equipped with infrared illumination 28 so as to be able to record evaluable video frames even under poor visibility conditions, such as at night. The infrared illumination 28 is preferably mechanically connected to the PTZ camera 10 to light the monitoring space S in the viewing direction of the PTZ camera 10. The infrared illumination has, for example, a wavelength of 850 nm or 940 nm, which can be detected by the PTZ camera 10 used. The PTZ camera can optionally also be provided with a gated viewing functionality.

The PTZ camera 10 can operate in non-zoom mode, in which it scans the monitoring space S with a low zoom factor as the base setting. In so doing, the PTZ camera 10 stays in each case for a few seconds in one direction. The PTZ camera 10 can additionally operate in zoom mode, in which it zooms in on a region of interest (R) in the monitoring space S with a greater zoom factor.

The PTZ camera 10 is connected to a control unit 12, which controls the PTZ camera 10 and evaluates the video frames captured by the PTZ camera 10 preferably using neural networks. The control unit 12 also contains a memory 13 for storing the video frames captured by the PTZ camera 10. Optionally, the control unit 12 can also have a memory or be connected to a memory in which image data are stored for the purpose of comparing them to the video frames captured. The image data, which are used for training the neural networks using deep learning or for a comparative evaluation, contain image data of real flying objects, image data of the monitoring space with real flying objects, image data of the monitoring space that have been synthetically supplemented with flying objects or scenarios, and the like.

The control unit 12 is connected to a monitor 14 so as to display the video frames captured by the PTZ camera 10 and the evaluation results of the control unit 12 to a user of the monitoring apparatus. The control unit 12 is additionally connected to an input apparatus 16, via which a user of the monitoring apparatus can input control commands, for example.

In the exemplary embodiment of FIG. 1, the control unit 12 additionally has an interface 18, via which it can be coupled to a network 20. The control unit 12 can be connected to a remote user 24 via the network 20 (for example radio network or Internet) to communicate the evaluation results to a remote user 24 and/or to receive control commands from the remote user 24. The control unit 12 can also communicate the evaluation results via the network 20 to an existing security system 26 at a protected location (for example prison, airport, military facility, government building, etc.).

In a modification of the first exemplary embodiment of FIG. 1, the camera arrangement of the monitoring apparatus can also have a plurality of PTZ cameras 10 that can be controlled independently of one another to scan and zoom independently of one another. The plurality of PTZ cameras 10 can then scan the monitoring space S in non-zoom mode all at the same time or can zoom in on a region of interest R or on different regions of interest R in zoom mode all at the same time or can operate partly in non-zoom mode and partly in zoom mode.

FIG. 2 shows a second exemplary embodiment of a monitoring apparatus according to the invention. In FIG. 2, identical or corresponding components are denoted using the same reference numerals as in FIG. 1.

The second exemplary embodiment differs from the first exemplary embodiment in particular in that the camera arrangement for video monitoring the monitoring space S not only has a PTZ camera 10 (or optionally a plurality of PTZ cameras), but additionally has a plurality of static cameras 30. The static cameras 30 can optionally be provided with fisheye lenses so as to be able to cover larger fields of view. The static cameras 30 can optionally also be provided with a gated viewing functionality. In non-zoom mode of the camera arrangement, the static cameras 30 capture video frames with a low zoom factor, wherein the video frames of all static cameras 30 cover the entire monitoring space S. The fields of view of the static cameras 30 are preferably aligned with respect to one another in a manner such that the video frames thereof can be combined on the monitor 14 to form a wide panorama image of the entire monitoring space S for the user. In zoom mode of the camera arrangement, the static cameras 30 can optionally continue to capture video frames of the entire monitoring space S with a low zoom factor so as to continue to display to the user a wide panorama image of the entire monitoring space S and additionally a marking of the zoomed region of interest Ron the monitor 14.

The PTZ camera 10 can be selectively used only in zoom mode of the camera arrangement or first in non-zoom mode and then in zoom mode of the camera arrangement. In a modification of the second exemplary embodiment of FIG. 2, the camera arrangement of the monitoring apparatus can likewise have a plurality of PTZ cameras 10 that can be controlled independently of one another to scan and zoom independently of one another.

The camera arrangement of FIG. 2 can optionally also be equipped with infrared illumination that illuminates the entire monitoring space S so as to be able to record evaluable video frames even under poor visibility conditions, such as at night. The infrared illumination has, for example, a wavelength of 850 nm or 940 nm, which can be detected by the cameras 10, 30 used.

For the rest, the construction of the monitoring apparatus of FIG. 2 corresponds to that of the first exemplary embodiment from FIG. 1.

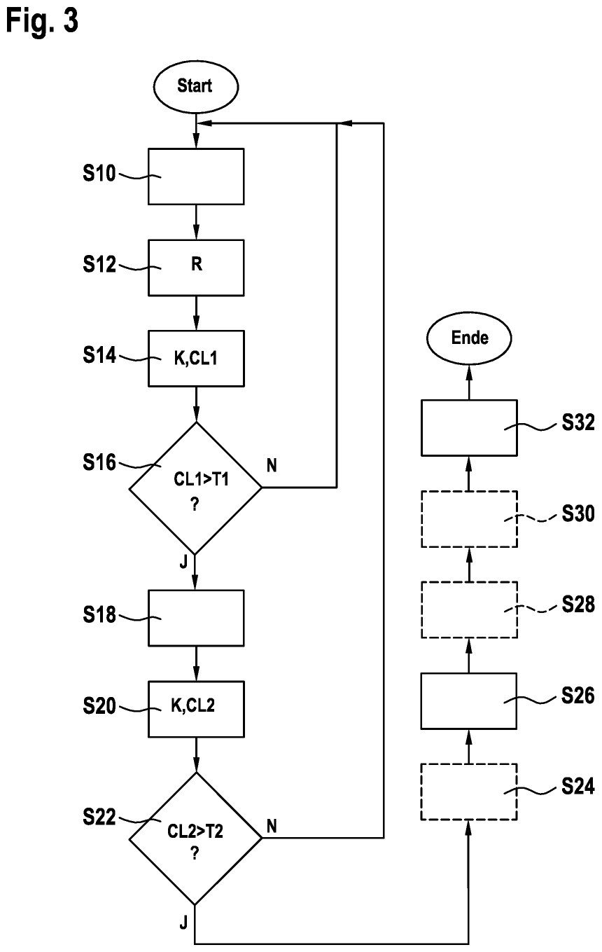

With reference to FIG. 3, the function of a monitoring apparatus according to the invention as per FIG. 1 or FIG. 2 will now be explained by way of example.

In a first step, S10, the camera arrangement is operated in non-zoom mode to capture video frames of the entire monitoring space S with a low zoom factor. In the embodiment of FIG. 1, the one PTZ camera 10 scans the monitoring space S, and in the embodiment of FIG. 2, the plurality of static cameras 30 (and optionally additionally the PTZ camera 10) capture the monitoring space S.

In the next step, S12, the control unit 12 evaluates the video frames captured by the camera arrangement in non-zoom mode and determines one or more regions of interest R in which flying objects N, O are located. The determined regions of interest R can be defined, for example, as what are known as bounding boxes, which contain the space coordinates of the four corner points.

This is followed, in step S14, by a first stage of classification for each of the regions of interest R determined in step S12 in order to pre-classify whether a flying object of interest O has possibly been recorded in the determined region of interest R. In a first embodiment variant, for each flying object class K, probability values for the presence of a flying object of the respective flying object class K are ascertained for the entire bounding box, and said ascertained probability values for all flying object classes K of flying objects of interest O and of flying objects that are able to be confused with them are then added up to a first probability CL1 (as an alternative to the addition of all these probability values, it is also possible to add up only the probability values for a UAV or the probability values of all UAV types or of a group of specific UAV types or to consider only the probability values of one or more specific UAV types or flying object classes K individually). The ascertainment of the probability values can in this case also be performed pixel by pixel in the bounding box, wherein, rather than assigning a single flying object class K with a corresponding probability value to the entire bounding box, each pixel is assigned a flying object class K and a corresponding probability value to refine the evaluation of the video frames in this manner. The ascertainment of the probability values is preferably effected in the form of confidence levels and as average values of the confidence levels of a plurality of successively recorded video frames.

The classification step S14—just as the second classification step S20 which will be described below—is preferably performed using neural networks. In order to improve the quality of this/these classification(s), the neural networks are preferably also trained in deep learning using synthetic images. In other words, in addition to image data of real flying objects and image data of the monitoring space with real flying objects, image data of the monitoring space that have been synthetically supplemented by flying objects or scenarios are also used.

Subsequently, the ascertained first probability CL1 is compared to a first limit value T1 of for example 0.4 (step S16). If the first probability CL1 falls under the first limit value T1, the assessment is that there is no flying object of interest O in the region of interest R, and the method returns to step S10 to continue to monitor the monitoring space S in non-zoom mode of the camera system. If by contrast the first probability CL1 exceeds the first limit value T1, the assessment is that there probably is a flying object of interest O in the region of interest R, and the method proceeds to step S18.

In step S18, the control unit 12 switches the camera arrangement to zoom mode. In zoom mode, the PTZ camera 10 zooms in the direction of the region of interest R which was determined in step S12 and in which there is assumed to be located a flying object of interest O. To this end, the control unit 12 for example passes on target coordinates of the determined region of interest R to the PTZ camera 10.

In the next step, S20, the control unit 12 evaluates the video frames captured by the PTZ camera 10 in a second stage of classification by ascertaining a second probability CL2 of the presence of a flying object of interest O in this zoomed region of interest R. In this second classification stage, only probability values for the presence of a flying object of interest O are ascertained; that is to say, the additional ascertainment of probability values for the presence of similar flying objects and the adding up of the different probability values are dispensed with. This ascertainment of the second probability CL2 is performed similarly to the ascertainment of the first probability CL1, preferably likewise using neural networks and as an average value of the confidence levels over a plurality of successively recorded video frames and optionally likewise on a pixel basis.

Subsequently, the ascertained second probability CL2 is compared to a second limit value T2 of for example 0.8 (step S22). If the second probability CL2 falls under the second limit value T2, the assessment is that there is no flying object of interest O in the region of interest R after all, and the method returns to step S10 to continue to monitor the monitoring space S in non-zoom mode of the camera system. If by contrast the second probability CL2 exceeds the second limit value T2, the assessment is that there is a flying object of interest O in the region of interest R, and the method proceeds to the next steps S24 to S32.

The first classification stage preferably continues to run continuously in parallel with the described second classification stage in zoom mode of the camera arrangement. In other words, while at least one PTZ camera 10 zooms in on a region of interest R that was determined in the first classification stage and the corresponding second classification stage is performed, the static cameras 30 (or further PTZ cameras 10) continue to monitor the monitoring space S with a low zoom factor, and a first classification stage is performed to this effect. In this way it is ensured that the monitoring space S is continuously monitored, and flying objects of interest O can be continuously captured and recognized.

After a flying object of interest O has been recognized, it is optionally also possible to perform a distance measurement of the recognized flying object of interest O (step S24). This distance determination can be performed, in the case of a camera arrangement having a plurality of cameras 10, 30, for example using a triangulation method or alternatively only with one PTZ camera 10 on the basis of the zoom factor and a known size of the identified flying object O.

The evaluation result is then communicated to the user on the monitor 14 and/or acoustically (step S26). Optionally, the evaluation result is also passed on to a remote user 24 and/or to an existing security system at a protected location 26 via the interface 18 of the control unit 12 through the network 20 (step S28). It is possible in particular to communicate a warning signal that a flying object of interest O in the monitoring space S has been recognized to a remote user 24 or to an existing security system 26. It is also possible to automatically couple the evaluation results of the drones O tracked with the monitoring apparatus to the fields of view of cameras in an existing security system 26. In this way, it is possible to show the guards in a prison for example which camera of the security system will shortly show a drone or a package that is transported and deposited by a drone.

In addition, the flying object of interest O identified in the region of interest R can optionally be tracked using the PTZ camera 10 (step S30). When tracking, the pan and tilt angles of the PTZ camera 10 are set such that the flying object of interest O is centred in the zoomed region of interest R. The speeds for the zoom movement and for the pan and tilt movements of the PTZ camera 10 are set separately because the zoom movement should be significantly slower so as not to miss the flying object of interest O, whereas the pan and tilt movements must be significantly quicker so as not to lose the flying object of interest O from the zoomed region of interest R.

Finally, the video frames captured by the camera arrangement 10, 30 are stored in the memory 13 (step S32). The stored video frames can be used later for example for checking the evaluation of the video frames or to demonstrate the evaluation result.

1. An apparatus for capturing flying objects, the apparatus comprising:
a camera system having at least one camera for video monitoring a monitoring space, said camera system configured to selectively operate in a non-zoom mode or in a zoom mode; and
a controller for controlling said camera system and evaluating video frames captured by said camera system, said controller configured to determine a region of interest with a flying object based on the video frames captured by said camera system in the non-zoom mode and to ascertain a first probability of a presence of the flying object of interest in the region of interest in order to switch said camera system to the zoom mode in a direction of the region of interest determined if a first limit value is exceeded by a first probability ascertained in order to ascertain a second probability of a presence of the flying object of interest in the region of interest on a basis of the video frames captured by said camera system in the zoom mode and to recognize the flying object of interest in the region of interest if a second limit value is exceeded by the second probability.

2. The apparatus according to claim 1, wherein said camera is at least one pan-tilt-zoom camera, which can selectively operate in the non-zoom mode or in the zoom mode.

3. The apparatus according to claim 1, wherein said camera includes at least one static camera that operates only in the non-zoom mode and at least one pan-tilt-zoom camera that can operate in the zoom mode.

4. The apparatus according to claim 1, wherein said camera is at least one camera with a gated viewing functionality.

5. The apparatus according to claim 1, wherein said camera is at least one black-and-white camera.

6. The apparatus according to claim 1, wherein said controller has an interface for passing on evaluation results to an existing security system at a protected location and/or to a remote user.

7. A method for capturing flying objects, which comprises the steps of:
capturing video frames of a monitoring space using a camera system having at least one camera in a non-zoom mode;
determining a region of interest with a flying object based on the video frames captured by the camera system in the non-zoom mode;
ascertaining a first probability of a presence of a flying object of interest in the region of interest determined;
capturing the video frames using the camera system in a zoom mode in a direction of the region of interest if the first probability exceeds a first limit value;
ascertaining a second probability of the presence of the flying object of interest in the region of interest on a basis of the video frames captured by the camera system in the zoom mode; and
recognizing the flying object of interest in the region of interest if the second probability exceeds a second limit value.

8. The method according to claim 7, which further comprises capturing the video frames in the zoom mode of the camera system using at least one pan-tilt-zoom camera.

9. The method according to claim 7, which further comprises capturing the video frames in the non-zoom mode of the camera system using at least one pan-tilt-zoom camera and/or at least one static camera.

10. The method according to claim 7, which further comprises accomplishing the ascertaining of the first probability and/or the ascertaining of the second probability of the presence of the flying object of interest in the region of interest by evaluating the video frames captured by the camera system using neural networks.

11. The method according to claim 7, which further comprises accomplishing the ascertaining of the first probability and/or the ascertaining of the second probability of the presence of the flying object of interest in the region of interest by assigning flying object classes to each pixel in the region of interest.

12. The method according to claim 7, which further comprises tracking a recognized flying object of interest in the region of interest using the camera system in the zoom mode.

13. The method according to one of claim 7, which further comprises determining a distance to a recognized flying object of interest in the region of interest.

14. The method according to claim 7, wherein if the flying object of interest in the region of interest was recognized, the results of the flying object capturing are passed on to an existing security system at a protected location and/or to a remote user.

15. The method according to claim 7, which further comprises storing the video frames captured by the camera system.
